(19) United States
(12) Patent Application Publication
(10) Pub. No.: US 2021/0216918 A1
(43) Pub. Date: Jul. 15, 2021

(54) USE OF OCCUPANCY ROOM SENSORS TO MANAGE MEETINGS IN MEETING ROOMS

(71) Applicant: Carrier Corporation, Palm Beach Gardens, FL (US)

(72) Inventor: Nadeem Shaikh, Madhapur, Hyderabad (IN)

(21) Appl. No.: 17/057,834

(22) PCT Filed: Sep. 19, 2019
(86) PCT No.: PCT/US2019/051810

§ 371 Date: Nov. 23, 2020

(30) Foreign Application Priority Data
Sep. 24, 2018 (IN) 201811035839

(51) Int. Cl. G06Q 10/02; G05B 19/4155; G08B 5/22

(52) U.S. Cl. CPC G06Q 10/02; G05B 2219/50333; G08B 5/22; G05B 19/4155

(57) ABSTRACT

A method of occupancy room sensors includes obtaining a reservation for a meeting location, the reservation at a meeting time and reserved by a user. It is determined whether the meeting location is occupied within a first threshold time period subsequent to the meeting time. Based on determining that the meeting location is not occupied within the first threshold time period, an alert is sent to the user. The alert includes a reminder of the meeting location and the meeting time. It is determined whether the meeting location is occupied within a second threshold time period subsequent to the meeting time. The second threshold time period is longer than the first threshold time period. It is requested that the reservation be cancelled based at least in part on determining that the meeting location is not occupied within the second threshold time period.

### BACKGROUND

The subject matter disclosed herein generally relates to the field of scheduling systems, and more particularly to an apparatus and method for using occupancy room sensors to manage meetings in meeting rooms.

Meeting rooms in office buildings are often reserved by employees for a single planned meeting or for a series of planned meetings. For example, a meeting organizer may reserve a conference room for every Tuesday from 3 p.m. to 5 p.m. for a project status meeting, or for Monday June 1^{st} from 1 p.m. to 2 p.m. for a department meeting. When the planned meetings are canceled or rescheduled, the meeting organizer may forget to communicate the change to the reservation software. This can lead to the meeting room being unoccupied but not appearing to be available when other employees are trying to locate an available conference room using the reservation software. In addition, a building automation system may set the environmental conditions of the room, such as temperature and lighting, based on the assumption that the room is occupied during a particular time period.

### BRIEF SUMMARY

According to an embodiment, a method of using occupancy room sensors to manage meetings in meeting rooms is provided. The method includes obtaining a reservation for a meeting location, the reservation at a meeting time and reserved by a user. It is determined whether the meeting location is occupied within a first threshold time period subsequent to the meeting time. Based at least in part on determining that the meeting location is not occupied within the first threshold time period, an alert is sent to the user. The alert includes a reminder of the meeting location and the meeting time. It is determined whether the meeting location is occupied within a second threshold time period subsequent to the meeting time. The second threshold time period is longer than the first threshold time period. It is requested that the reservation be cancelled based at least in part on determining that the meeting location is not occupied within the second threshold time period. Subsequent to the reservation being cancelled, the meeting location is available for reservation.

In addition to one or more of the features described above or below, or as an alternative, further embodiments of the method may include changing an environmental set point of the meeting location in response to requesting that the reservation be cancelled.

In addition to one or more of the features described above or below, or as an alternative, further embodiments of the method may include that the environmental set point includes at least one of a temperature at the meeting location and lighting at the meeting location.

In addition to one or more of the features described above or below, or as an alternative, further embodiments of the method may include notifying a second user that the meeting location is available based at least in part on requesting that the reservation be cancelled.

In addition to one or more of the features described above or below, or as an alternative, further embodiments of the method may include that the second threshold time period is modified based on an estimated time that the alert was received by the user.

In addition to one or more of the features described above or below, or as an alternative, further embodiments of the method may include that the first and second thresholds are programmable.

In addition to one or more of the features described above or below, or as an alternative, further embodiments of the method may include that the first and second thresholds are programmable based on at least one of the meeting location, the meeting time, and the user who reserved the meeting location.

In addition to one or more of the features described above or below, or as an alternative, further embodiments of the method may include determining whether the meeting location is occupied is based at least in part on output from a sensor located at the meeting location.

In addition to one or more of the features described above or below, or as an alternative, further embodiments of the method may include that the alert is sent to the user via an email message.

In addition to one or more of the features described above or below, or as an alternative, further embodiments of the method may include that the alert is sent to the user via a text message or an online chat message.

In addition to one or more of the features described above or below, or as an alternative, further embodiments of the method may include sending an additional alert to a meeting participant other than the user based at least in part on determining that the meeting location is not occupied within a first threshold time period subsequent to the meeting time.

According to another embodiment, a system of using occupancy room sensors to manage meetings in meeting rooms is provided. The system includes a processor and a memory. The memory includes computer-executable instructions that, when executed by the processor, cause the processor to perform operations. The operations include obtaining a reservation for a meeting location, the reservation at a meeting time and reserved by a user. It is determined whether the meeting location is occupied within a first threshold time period subsequent to the meeting time. Based at least in part on determining that the meeting location is not occupied within the first threshold time period, an alert is sent to the user. The alert includes a reminder of the meeting location and the meeting time. It is determined whether the meeting location is occupied within a second threshold time period subsequent to the meeting time. The second threshold time period is longer than the first threshold time period. It is requested that the reservation be cancelled based at least in part on determining that the meeting location is not occupied within the second threshold time period. Subsequent to the reservation being cancelled, the meeting location is available for reservation.

In addition to one or more of the features described above or below, or as an alternative, further embodiments of the system may include that the operations further include changing an environmental set point of the meeting location in response to requesting that the reservation be cancelled.

In addition to one or more of the features described above or below, or as an alternative, further embodiments of the system may include that the environmental set point includes at least one of a temperature at the meeting location and lighting at the meeting location.

In addition to one or more of the features described above or below, or as an alternative, further embodiments of the system may include that the operations further comprise notifying a second user that the meeting location is available based at least in part on requesting that the reservation be cancelled.

In addition to one or more of the features described above or below, or as an alternative, further embodiments of the system may include that the second threshold time period is modified based on an estimated time that the alert was received by the user.

In addition to one or more of the features described above or below, or as an alternative, further embodiments of the system may include that the first and second thresholds are programmable.

In addition to one or more of the features described above or below, or as an alternative, further embodiments of the system may include that the determining whether the meeting location is occupied is based at least in part on output from a sensor located at the meeting location.

In addition to one or more of the features described above or below, or as an alternative, further embodiments of the system may include that the alert is sent to the user via one of an email message, a text message, and an online chat message.

In addition to one or more of the features described above or below, or as an alternative, further embodiments of the system may include that the operations further include sending an additional alert to a meeting participant other than the user based at least in part on determining that the meeting location is not occupied within a first threshold time period subsequent to the meeting time.

Technical effects of embodiments of the present disclosure include the ability for employees to find available meeting rooms using conference room reservation software on short notice. Technical effects also include preventing underutilization of meeting rooms and allowing meeting rooms to be used more effectively. Technical effects also include saving energy resources and efficient energy management.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

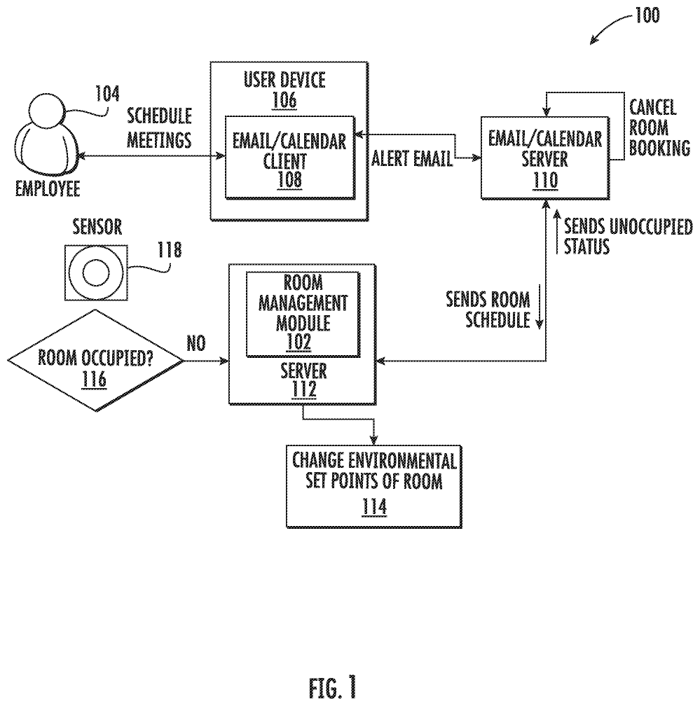

FIG. 1 illustrates a schematic diagram of using occupancy room sensors to manage meetings in meeting rooms, in accordance with an embodiment of the disclosure; and

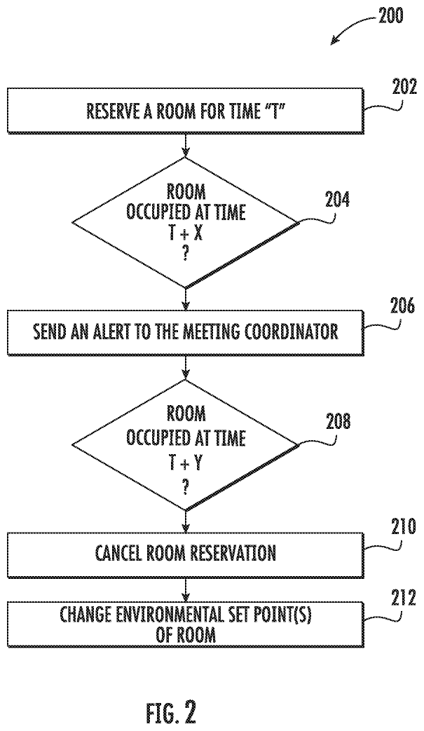

FIG. 2 is a flow diagram illustrating a method of using occupancy room sensors to manage meetings in meeting rooms, in accordance with an embodiment of the disclosure.

### DETAILED DESCRIPTION

A detailed description of one or more embodiments of the disclosed apparatus and method are presented herein by way of exemplification and not limitation with reference to the Figures.

One or more embodiments of the present invention provide a system and method for using occupancy room sensors to manage meetings in meeting rooms. In accordance with one or more embodiments of the present invention, a room (e.g., a conference room or meeting room) is reserved for a particular time frame and a sensor in the room is used to detect room occupation during that particular time frame. If the room occupancy sensor detects that the room is not occupied, for example, five minutes after the meeting was scheduled to start, then an alert is sent to the person who reserved the room reminding them that they have reserved the room. The alert may be sent to the meeting coordinator in any manner known in the art such as, but not limited to, via an email message or via a text message. If the room is still not occupied, for example, six minutes after the alert is sent to the meeting coordinator, then the reservation of the room is cancelled and the room is available to be reserved by other employees. In accordance with one or more embodiments of the present invention, along with cancelling the reservation of the room, the meeting room set points, such as temperature and lighting are changed from set points for an occupied room to set points for an unoccupied room to save on energy consumption.

Turning now to FIG. 1, a schematic diagram 100 of using occupancy room sensors to manage meetings in meeting rooms is generally shown, in accordance with an embodiment of the disclosure. The schematic diagram 100 of FIG. 1 includes user device 106, email/calendar server 110, server 112, environmental set point control module 114, and sensor 118. As shown in FIG. 1, user device 106 includes an email/calendar client 108 in operable communication with email/calendar server 110 to schedule meetings and reserve conference rooms. As shown in FIG. 1, the user device 106 is also in operable communication with the email/calendar server 110 to receive alert messages when a conference room schedule for use by a user of the user device 106 is unoccupied. The software executing on the email/calendar server 110 and the email/calendar client 108 executing on the user device 106 may be implemented by any office software known in the art such as, but not limited to Outlook® from Microsoft. A user employee 104, acting as a meeting coordinator, or host, may schedule meetings through a user interface of the user device 106. The user device 106 is capable of secure bi-directional communication with the email/calendar server 110. The user device 106 may be a computing device such as a desktop computer. The user device 106 may also be a mobile computing device that is typically carried by a person, such as, for example a phone, PDA, smart watch, tablet, laptop, etc. The user device 106 may also be two separate devices that are synced together such as, for example, a cellular phone and desktop computer synced over an internet connection.

Though not shown in FIG. 1, the user device 106 may include a processor, a memory, and a communication module for implementing one or more communication protocols as described in further detail herein. The processor may be implemented by any type or combination of computer processors, such as but not limited to a microprocessor, microcontroller, digital signal processor, application specific integrated circuit, programmable logic device, and/or field programmable gate array. The memory may be implemented by any non-transitory computer readable storage medium tangibly embodied in the user device 106 including executable instructions stored therein, for instance, as firmware.

The email/calendar server 110 executing the email/calendar server software may include a processor, memory, and a communication module to implement one or more communication protocols as described further herein. The processor can be any type or combination of computer processors, such as a microprocessor, microcontroller, digital signal processor, application specific integrated circuit, programmable logic device, and/or field programmable gate array. The memory may be implemented by any non-transitory computer readable storage medium tangibly embodied in or operably connected to the path determination system including executable instructions stored therein, for instance, as firmware.

The software executing on the email/calendar server 110 manages schedule information that includes meeting room schedules. The meeting room schedules are the calendar schedule of each meeting location (e.g., in an office building or on a office campus or company-wide) including when the room is booked for a meeting and contact information for the reservation requestor, or coordinator of the meeting. The meeting locations are not limited to office buildings and corporations, as embodiments described herein may be applied any time that meeting locations are reserved in advance such as, but no limited to schools and college campuses. In an example, the software includes electronic calendars such as, but not limited to Microsoft Outlook Calendars, Gmail Calendars, iCloud Calendar, and Android Calendars. In accordance with one or more embodiments of the present invention, the software executing on the email/calendar server 110 is configured to reserve meeting rooms, to cancel meeting room reservations, and to transmit meeting room reservation schedule information to server 112. In addition, the software is configured to send an alert email to a meeting coordinator in response to being notified that a room reserved by the meeting coordinator starting at a specified start time and ending at a specified end time is unoccupied at the specified start time or within a first threshold time period of the specified start time. Further, the software is configured to cancel the room reservation based on being notified that the room remains unoccupied for a second threshold time period after the specified start time and/or after the alert email is sent to the meeting coordinator.

The first and second threshold time periods are programmable and may be the same for all meeting rooms and all meeting coordinators, or they may vary based on factors such as whether another employee is on a waiting list to reserve the room at the same time, the physical location of the meeting room, the length of the meeting, the job title of the meeting coordinator, the job titles of meeting participants, a subject of the meeting for the reserved meeting room, a time of day of the reservation, etc. For example, the first threshold time period may be three minutes for reservations before 3 p.m. and six minutes for meetings after 3 p.m., and the corresponding second threshold time period may be six minutes for reservations before 3 p.m. and nine minutes for reservations after 3 p.m. In another example, the first threshold is ten minutes and the second threshold is fifteen minutes for reservations for rooms in a first building. The factors may be combined in a variety of manners. For example, the first threshold may be eight minutes for executive level meeting coordinators for meeting locations in one building and five minutes for executive level meeting coordinators for meeting locations in another building.

Server 112 of FIG. 1 includes room management module 102 for performing at least a subset of the processing described herein, and may also include a processor, memory, and a communication module to implement one or more communication protocols as described further herein. The processor can be any type or combination of computer processors, such as a microprocessor, microcontroller, digital signal processor, application specific integrated circuit, programmable logic device, and/or field programmable gate array. The memory may be implemented by any non-transitory computer readable storage medium tangibly embodied in or operably connected to the path determination system including executable instructions stored therein, for instance, as firmware.

In an embodiment room management module 102 includes instructions for receiving the room schedule from the email/calendar server 110 and for determining whether a reserved room is occupied as shown at block 116 of FIG. 1. The determining is based on output from sensor 118. Sensor 118 may be implemented by any off the shelf sensor(s) known in the art that can detect whether a room is occupied such as, but not limited to a motion detector sensor and/or a camera sensor. In an embodiment, sever 112 is a building automation system server that include instructions to adjust environmental conditions of the room as shown in block 114 of FIG. 1. A set point can be specified for times when the room is occupied and another set point can be specified for times when the room is not occupied. The set points can specify environmental conditions such as, but not limited to temperature, humidity, and/or which lights are turned on or off in the room. The set point conditions can be monitored using other sensors such as temperature sensors and humidity sensors. In an embodiment server 112 executes WebCTRL® Building Automation System from Automated Logic to set and monitor heating, air conditioning and lighting systems in the meeting room, using different set points depending on whether the room is occupied or unoccupied.

The user device 106, email/calendar server 110, server 112, and sensor 118 communicate with each other via any one or more known short and/or long range communication protocols. The communication may be over a wired or wireless network, such as 802.11x (Wi-Fi), short-range radio (Bluetooth), cellular, satellite, etc. In example embodiments, the communication is over multiple independent wired and/or wireless networks. Embodiments are intended to cover a wide variety of types of communication and embodiments are not limited to the examples provided in this disclosure.

In the example embodiment shown in FIG. 1, email/calendar server 110 and server 112 are illustrated as separate systems. Various configurations may be implemented by other embodiments. For example in an embodiment, email/calendar server 110 and server 112 are included in the same system, or server. In another example embodiment, room management module 102 executes on the email/calendar server 110 along with the email/calendar software.

Turning now to FIG. 2, a flow diagram 200 illustrating a method of using occupancy room sensors to manage meetings in meeting rooms is generally shown, in accordance with an embodiment of the disclosure. All or a subset of the processing shown in FIG. 2 may be implemented by email/calendar client 108, email/calendar software executing on email/calendar server 110 and/or by room management module 102 executing on server 112. At block 202, a room, or meeting location, is reserved for a meeting starting at time “T” by a user such as employee 104 of FIG. 1. In an embodiment, the reservation is made using email/calendar client 108 on user device 106 of FIG. 1 interacting with email/calendar server 110 of FIG. 1. In an embodiment, a notification of the reservation is sent to room management module 102 of FIG. 1 by email/calendar server 110.

At block 204 it is determined whether the reserved meeting location is occupied at time “T+X”, where X is a programmable first threshold time period. That is, at block 204 it is determined whether the reserved meeting location is occupied within a first threshold time period “X” subsequent to meeting time “T”. In an embodiment, the first threshold time period is programmable based at least in part on a number of factors such as, but not limited to meeting location, meeting time, and the user who reserved the meeting location. In an embodiment, the determination is made by room management module 102 of FIG. 1 based at least in part on output from a sensor, such as sensor 118 of FIG. 1, located at the meeting location. If the room is not occupied at time “T+X”, then processing continues at block 206 with sending an alert to the user who made the reservation (e.g., the “meeting coordinator”). The alert may include a reminder to the user about the meeting start time and the meeting location, as well as an indication that the meeting location is currently unoccupied. In an embodiment, room management module 102 of FIG. 1 sends a request to email/calendar server 110 to send the alert to the user. In response to receiving the alert request, the email/calendar server 110 sends an alert email to the user, such as employee 104, via email/calendar client 108 executing on user device 106. The alert is not limited to being an email message and can be sent in any manner known in the art such as, but not limited to an email message, a text message, and/or an online chat message. The user can specify a preferred method of receiving alerts. An additional alert(s) can also be sent to a meeting participant or other specified individual(s).

At block 208, it is determined whether the reserved meeting location is occupied at time “T+Y”, where Y is a programmable second threshold time. That is, at block 208 it is determined whether the reserved meeting location is occupied within a second threshold time period “Y” subsequent to meeting time “T”. In an embodiment, the second threshold time period is longer than the first threshold time period and is programmable based at least in part on a number of factors such as, but not limited to meeting location, meeting time, and the user who reserved the meeting location. In an embodiment, the second threshold time period may be modified based on an estimated time that the alert was received by the user. In another embodiment, the second threshold time is based on a time that the alert was sent to the user. If the room is not occupied at time “T+Y”, then processing continues at block 210 and the room reservation is cancelled. In an embodiment, the room management module 102 of FIG. 1 sends a request to the email/calendar server 110 of FIG. 1 to cancel the reservation of the meeting location. Once the reservation for the meeting location has been cancelled, it is available to be reserved by other users. In an embodiment, where there is a waiting list for the meeting location, once the reservation has been cancelled, a second user from the waiting list is notified that the meeting location is available for reservation.

Flow proceeds from block 210 to block 212 where the room management module 102 may send a request to building automation control software to change the environmental set points of the meeting location to reflect its unoccupied status. The environmental set points may include, but are not limited to temperature at the meeting location, humidity at the meeting location, and lighting at the meeting location.

While the above description has described the flow process of FIG. 2 in a particular order, it should be appreciated that unless otherwise specifically required in the attached claims that the ordering of the steps may be varied.

While embodiments have been described herein in terms of a hotel and a school campus, it will be appreciated that embodiments can be utilized in any environment where access control devices are utilized such as, but not limited to office building and apartment buildings.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method of managing meeting room reservations, the method comprising:
obtaining a reservation for a meeting location, the reservation at a meeting time and reserved by a user;
determining whether the meeting location is occupied within a first threshold time period subsequent to the meeting time;
sending an alert to the user based at least in part on determining that the meeting location is not occupied within the first threshold time period, the alert comprising a reminder of the meeting location and the meeting time;
determining whether the meeting location is occupied within a second threshold time period subsequent to the meeting time, the second threshold time period longer than the first threshold time period; and
requesting that the reservation be cancelled based at least in part on determining that the meeting location is not occupied within the second threshold time period,
wherein subsequent to the reservation being cancelled, the meeting location is available for reservation.

2. The method of claim 1, further comprising changing an environmental set point of the meeting location in response to requesting that the reservation be cancelled.

3. The method of claim 2, wherein the environmental set point includes at least one of a temperature at the meeting location and lighting at the meeting location.

4. The method of claim 1, further comprising notifying a second user that the meeting location is available based at least in part on requesting that the reservation be cancelled.

5. The method of claim 1, wherein the second threshold time period is modified based on an estimated time that the alert was received by the user.

6. The method of claim 1, wherein the first and second threshold time periods are programmable.

7. The method of claim 1, wherein the first and second threshold time periods are programmable based on at least one of the meeting location, the meeting time, and the user who reserved the meeting location.

8. The method of claim 1, wherein the determining whether the meeting location is occupied is based at least in part on output from a sensor located at the meeting location.

9. The method of claim 1, wherein the alert is sent to the user via an email message.

10. The method of claim 1, wherein the alert is sent to the user via a text message or an online chat message.

11. The method of claim 1, further comprising sending an additional alert to a meeting participant other than the user based at least in part on determining that the meeting location is not occupied within a first threshold time period subsequent to the meeting time.

12. A system for managing meeting room reservations, the system comprising:
a processor; and
a memory comprising computer-executable instructions that, when executed by the processor, cause the processor to perform operations, the operations comprising:
obtaining a reservation for a meeting location, the reservation at a meeting time and reserved by a user;
determining whether the meeting location is occupied within a first threshold time period subsequent to the meeting time;
sending an alert to the user based at least in part on determining that the meeting location is not occupied within the first threshold time period, the alert comprising a reminder of the meeting location and the meeting time;
determining whether the meeting location is occupied within a second threshold time period subsequent to the meeting time, the second threshold time period longer than the first threshold time period; and
requesting that the reservation be cancelled based at least in part on determining that the meeting location is not occupied within the second threshold time period,
wherein subsequent to the reservation being cancelled, the meeting location is available for reservation.

13. The system of claim 12, wherein the operations further comprise changing an environmental set point of the meeting location in response to requesting that the reservation be cancelled.

14. The system of claim 13, wherein the environmental set point includes at least one of a temperature at the meeting location and lighting at the meeting location.

15. The system of claim 12, wherein the operations further comprise notifying a second user that the meeting location is available based at least in part on requesting that the reservation be cancelled.

16. The system of claim 12, wherein the second threshold time period is modified based on an estimated time that the alert was received by the user.

17. The system of claim 12, wherein the first and second threshold time periods are programmable.

18. The system of claim 12, wherein the determining whether the meeting location is occupied is based at least in part on output from a sensor located at the meeting location.

19. The system of claim 12, wherein the alert is sent to the user via one of an email message, a text message, and an online chat message.

20. The system of claim 12, wherein the operations further comprise sending an additional alert to a meeting participant other than the user based at least in part on determining that the meeting location is not occupied within a first threshold time period subsequent to the meeting time.
